(19) United States
(12) Patent Application Publication
(10) Pub. No.: US 2006/0078782 A1
(43) Pub. Date: Apr. 13, 2006

(54) Single-pass, high fuel concentration, mixed-reactant fuel cell generator apparatus and method

(76) Inventors: Jerry L. Martin, Superior, CO (US); Valerie A. Hovland, Boulder, CO (US)

Correspondence Address: COCHRAN FREUND & YOUNG LLC, 2026 CARIBOU DR, SUITE 200, FORT COLLINS, CO, 80525, US

(21) Appl. No.: 10/961,514

(22) Filed: Oct. 7, 2004

(51) Int. Cl. H01M 8/24; H01M 8/04

(52) U.S. Cl. 429/38; 429/13; 429/26

(57) ABSTRACT

A high concentration fuel mixed with oxidant is used to operate a fuel cell generator equipped with anode reaction and cathode reaction selective catalysts, wherein the fuel is substantially consumed in a single pass through the cells.

### CONTRACTUAL ORIGIN OF THE INVENTION

This invention was made with Government support under W911 NF-04-C-0009 awarded by the U.S. Army. The Government has certain rights in the invention.

### BACKGROUND OF THE INVENTION

1. Field of the Invention

This invention is related to fuel cells, and more specifically to compact mixed-reactant (CMR) type direct methanol fuel cells (DMFC).

2. State of the Prior Art

Fuel cell generators are electrochemical systems that consume fuel and an oxidant, for example, hydrogen or methane fuel and oxygen from the air, to produce electricity. A conventional fuel cell is generally comprised of a fuel electrode (anode), an oxidizer electrode (cathode), an electrolyte interposed between the fuel and oxidizer electrodes, a conduit to supply fuel to the fuel electrode, a conduit to supply oxidizer, e.g., air, to the oxidizer electrode, one or more conduits to carry byproducts of the chemical reactions away from the electrodes, and electric contacts for carrying electric current from the anode to a load and from the load to the cathode.

In direct methanol fuel cells (DMFC), which are leading candidates for development into power sources for portable electronic devices as well as other uses, the fuel is methanol, oxygen from the air or other sources can be used as the oxidant, and the byproducts are carbon dioxide and water. The chemical reactions are:

$$\begin{matrix}Anode reaction \text{:} {CH}_{3} OH + {H}_{2} O \to 6 {H}^{+} + {CO}_{2} + 6 {e}^{-} & ( 1 ) \\ Cathode reaction \text{:} \frac{3}{2} {O}_{2} + 6 {H}^{+} + 6 {e}^{-} \to 2 {H}_{2} O & ( 2 ) \\ Overall reaction \text{:} {CH}_{3} OH + \frac{3}{2} {O}_{2} \to {CO}_{2} + 2 {H}_{2} O & ( 3 )\end{matrix}$$

The methanol and water are provided to the anode from a fuel storage tank or other source. The hydrogen protons (6H⁺) produced by the anode reaction—Equation (1)—migrate through the electrolyte to the cathode to take part in the cathode reaction—Equation (2), while the electrons (6e⁻) flow as electricity from the anode, through the load, and to the cathode to take part in the cathode reaction—Equation (2), where the oxidant reacts with the protons and acquires the electrons to form water.

It is undesirable for the methanol to come in contact with the cathode in a conventional direct methanol fuel cell (DMFC), because the methanol will react with the oxidant at the cathode to form carbon dioxide and water, as follows:

$$Cross \text{-} over reaction \text{:} {CH}_{3} OH + \frac{3}{2} {O}_{2} \to {CO}_{2} + 2 {H}_{2} O \qquad ( 4 )$$

That kind of reaction consumes methanol without production of electrons to do work, thus is wasted, and it reduces the fuel cell potential and efficiency. Therefore, for a conventional direct methanol fuel cell (DMFC) to work efficiently, the anode and the cathode have to be separated by a selective membrane, which will allow the protons (6H⁺ from equation (1)) to migrate from the anode side of the fuel cell through the selective membrane to the cathode side while preventing the methanol from getting through the membrane to the cathode side. See, for example, U.S. Pat. 6,613,464 issued to Wilkinson et al. and U.S. Pat. No. 6,723,678 issued to Gorer.

While some electrolyte membranes have been developed to be at least somewhat selective to allow proton migration and disallow methanol migration, they are not perfect. So far, it has not been possible to prevent all the methanol from crossing the membranes to reach the cathode and participating in the parasitic reaction of equation (4) above, which reduces efficiency of the fuel cell. Therefore, to reduce such cross-over loss and consequent waste of the methanol fuel, most conventional DMFC systems dilute the methanol with water, typically in the range of 1-10% methanol and recirculate the solution indefinitely across the anodes while adding enough fuel to compensate for the fuel consumed and to keep the diluted fuel concentration in a tightly controlled range. Unfortunately, such dilution and recirculation of the methanol, while reducing waste of fuel and solving the problem of low per-pass utilization of the fuel, adds considerably to the complexity, size, and weight of the conventional DMFC systems, i.e., the balance-of-plant (BOP), with additional plumbing, pump, concentration sensors and methanol injection systems to keep the methanol concentration within narrow bounds, carbon dioxide separator to remove bubbles from the recirculation stream, and other components. Further, the necessity of using diluted methanol requires the choice of either carrying a supply of concentrated methanol and diluting it on site as part of the system, which requires still more complexity in water collection and recovery equipment, or that diluted fuel be carried, which adds weight and reduces available fuel energy.

A recent development of mixed-reactant fuel cells eliminates the need for the selective membrane to keep the methanol fuel away from the cathode in the conventional DMFC systems by providing selective anode and cathode catalysts that produce only the desired reactions at the anode and cathode, i.e., equations (1) and (2) above, respectively. See, for example, Patent Application Publications No. US 2004/0058203 A1 and US 2003/0165727 A1 by Priestnall et al., both of which are incorporated herein by reference. However, simply substituting a mixed-reactant stack of cells into a conventional DMFC generator with its diluted methanol fuel and consequent low-per-pass fuel utilization only exacerbates the balance-of-plant problem. For example, since the reactants are all mixed together, it is necessary not only to separate the unutilized methanol fuel from the carbon dioxide as described above, but also from the water and depleted air from the stack. Simply condensing to liquid phases is insufficient, because more water is produced (see equations (2) and (3) above) than is required for the dilution of the methanol in the recirculation. Also, venting the mixed-reactant exhaust is unacceptable, because the partial pressure of methanol is low enough to cause methanol in the exhaust stream to exceed permissible exposure level to humans by a factor of more than 350, and toxic methanol vapor could build up quickly in vehicles or small rooms from such exhaust. Mitigating schemes that rely on reverse distillation of methanol from the methanol/water mixture would be heavy, bulky, slow, and fragile.

### SUMMARY OF THE INVENTION

A general object of this invention, therefore, is to provide a higher energy density, higher efficiency, and lower cost fuel cell generator.

Another object of this invention is to further develop mixed-reactant, direct methanol fuel cells into more efficient, higher energy density, and less complex generator systems with less balance-of-plant than previous systems described above.

To achieve the above and other objects of this invention, it was first conceived and recognized that mixed-reactants, i.e., fuel and oxidant, used in a fuel cell with anode reaction selective catalysts and cathode reaction selective catalysts do not have to be diluted to, and maintained in, a low concentration band for efficient fuel cell operation, as necessary for conventional DMFC systems. Instead, such fuel cells can operate efficiently over a broad range of concentrations. That realization then lead to the next conception and realization that, the fuel does not have to be recirculated, but instead can be mixed in a high fuel concentration along with the oxidant and consumed in one pass through one or more fuel cells with anode reaction and cathode reaction selective catalysts. In a preferred embodiment, the high fuel concentration/oxidant mixture is flowed sequentially through a series of such fuel cells, wherein each cell consumes an incremental additional amount of the fuel.

### BRIEF DESCRIPTION OF THE DRAWINGS

The accompanying drawings, which are incorporated in and form a part of the specification, illustrate the preferred embodiments of the invention and, together with the descriptions, serve to explain the principles of the invention. In the drawings:

FIG. 1 is a schematic diagram of a sequence of fuel cells in a stack to illustrate a mixed-reactant flow and the consumption of the fuel in a single-pass of the mixed-reactant flow through the stack to produce electric current;

FIG. 2 is a graph comparing efficiency of mixed-reactant fuel cells to efficiency of conventional direct methanol fuel cells (DMFC) as a function of methanol concentration;

FIG. 3 is an exploded view of the components comprising a mixed-reactant, axial flow fuel cell used in this invention;

FIG. 4 is an exploded view of an example matrix stack of mixed-reactant, parallel flow fuel cells used in this invention;

FIG. 5 is a schematic diagram of a preferred embodiment mixed-reactant fuel cell system of this invention; and

FIG. 6 is a schematic diagram of a conventional, prior art direct methanol fuel cell (DMFC) system provided to contrast the balance-of-plant complexity of such prior art DMFC systems to the mixed-reactant fuel cells system of this invention.

### DETAILED DESCRIPTION OF THE PREFERRED EMBODIMENTS

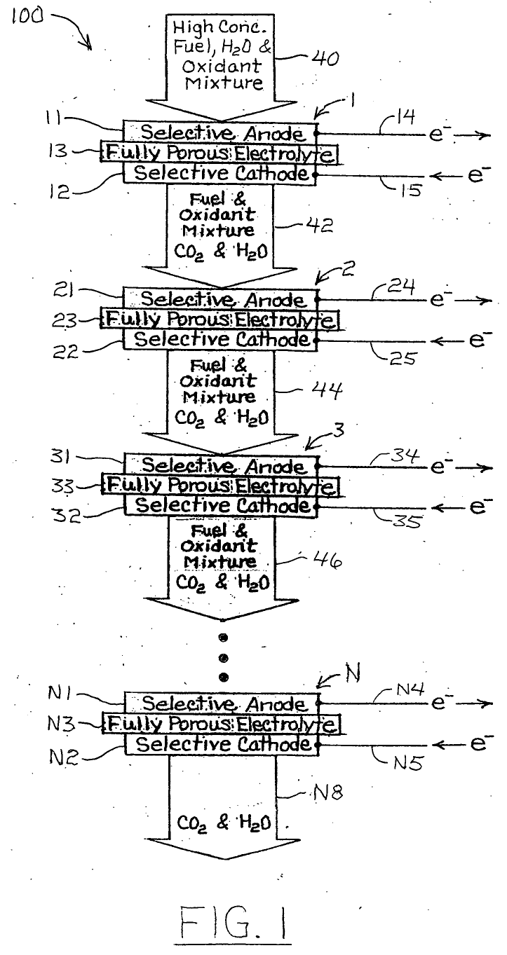

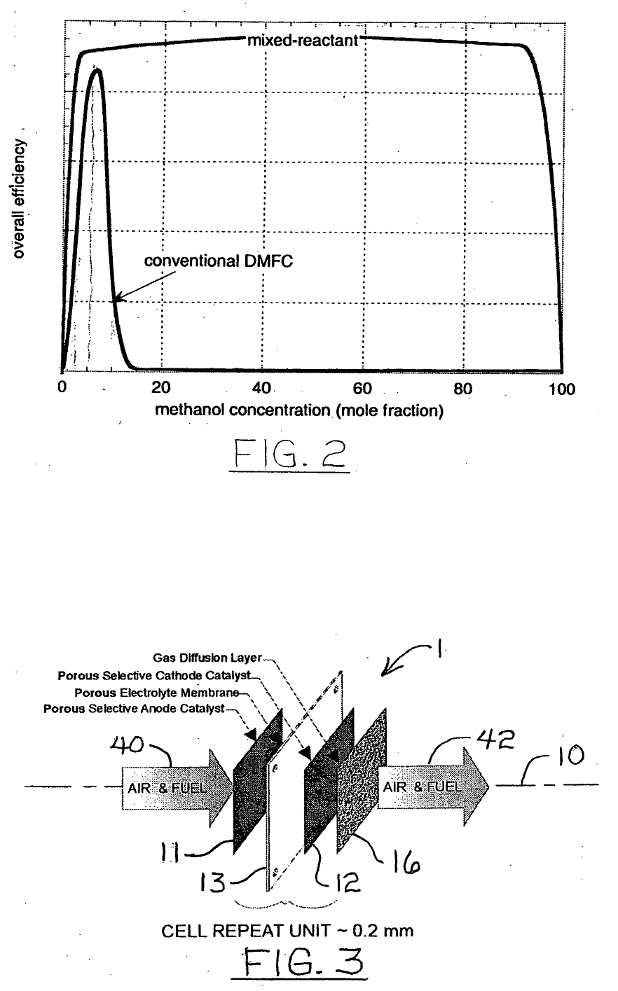

The mixed-reactant, high concentration fuel cell system 100 of this invention is based on the conception and then recognition that mixed-reactants flowing through a stack comprising a series of electrodes coated with selective catalysts, i.e., a first catalyst that enables the anode reaction of Equation (1) above and a second catalyst that enables the cathode reaction of Equation (2) above, enables the full utilization of a highly concentrated fuel in a single-pass, as illustrated schematically in FIG. 1. Because there is no cross-over problem, the fuel in the cells 1, 2, 3, . . . , N does not have to be diluted, as it does in conventional DMFC systems. As illustrated by the graph in FIG. 2, the fuel cells in conventional DMFC systems can operate efficiently only in a very narrow range of methanol concentration, e.g., about 2 to 8 percent (mole fraction), whereas mixed-reactant fuel cells with the selective anode and cathode catalysts (assuming 100% selective catalysts) can operate efficiently over a broad range of methanol concentrations, e.g., about 1-97 percent (mole fraction). Anode reaction selectivity of 95% has been demonstrated with platinum-ruthenium and cathode selectivity of 75% has been demonstrated with ruthenium-selenium (Ru—Se). It is believed that further improvements in selectivity for both anode and cathode catalysts will be achieved. Therefore, instead of having to maintain the fuel in a tightly-controlled concentration range and recirculating the fuel-water mixture over and over again across the anode while oxidant is fed in a separate stream to the cathode, as is done in conventional DMFC systems, the fuel in the present invention can be fed in an initially highly concentrated mixture in an influent stream 40 in a sequential manner through a plurality of fuel cells 1, 2, 3, . . . , N until substantially all of the fuel is consumed. Each of the fuel cells 1, 2, 3, . . . , N consumes some of the fuel in the stream 40, 42, 44, 46, until only carbon dioxide and water are left in the final effluent N8 from the last cell N.

In FIG. 1, an initial flow stream 40 comprising a mixture of highly concentrated fuel, e.g., methanol, mixed with an oxidant, is directed sequentially through a stack 100 of fuel cells, for example, cells 1, 2, 3, . . . , N. Each cell 1, 2, 3, . . . , N comprises a selective anode 11, 21, 31, . . . , N1, respectively, and a selective cathode 12, 22, 32, . . . , N2, respectively, separated by a fully porous or permeable membrane 13, 23, 33, . . . , N3, respectively. The initial influent flow 40 comprises a mixture of highly concentrated fuel for the anode reactions (equation (1) above) with enough water for at least the first cell anode reaction (equation (1) above), and oxidant for the cathode reactions (equation (2) above). As this initial flow 40 of mixed-reactants flows through the first cell 1, some amount of the fuel is consumed by the anode reaction to produce protons (6H⁺), electrons (e⁻), and carbon dioxide (CO₂), as shown by equation (1) above, and the cathode reaction consumes some amount of the oxidant

$$( \frac{3}{2} {O}_{2} )$$

along with the protons (6H⁺) and electrons (6e⁻) to produce more water, as shown by equation (2) above. Suitable contacts 14, 15 connected to the anode 11 and cathode 12, respectively, conduct electrons (e⁻) produced at the anode 11 in an electric current to power a load (not shown) and to conduct the electric current (e⁻) back to the cathode 12.

The result of the reactions in the first cell 1, therefore, is that some of the initial highly concentrated fuel is consumed, as is some of the initial oxidant, and electric current is produced to power a load, which can include storage (e.g., charging a rechargeable battery, capacitor, etc.) for later use. Also, additional water is produced in the first cell 1, which is available for use in the anode reactions in subsequent cells 2, 3, . . . , N, and the carbon dioxide byproduct is produced. Consequently, the fuel in the effluent mixture 42 from the first cell 1 is somewhat more dilute than the highly concentrated fuel in the initial flow 40, but is still available for consumption in the second cell 2. Also, the effluent flow 42 from the first cell 1 contains oxidant that was not consumed in the first cell 1, water, and the carbon dioxide byproduct from the first cell.

The effluent stream 42 from the first cell 1 is the influent to the second cell 2. Additional incremental amounts of the fuel and oxidant in the stream 42 are consumed in the second cell 2 to produce electric current through the contacts 24, 25, thereby producing more carbon dioxide and water, so the fuel and oxidant in the effluent stream 44 from the second cell 2 are somewhat more diluted than the effluent stream 42 from the first cell 1. Likewise, the effluent stream 44 is the influent stream to the third cell 3, which consumes still more of the fuel and oxidant to produce electric current through the contacts 34, 35 and more carbon dioxide and water in the effluent 46 of the third cell 3.

As illustrated schematically by the three dots and last cell N in FIG. 1, this sequence continues through whatever number N cells is needed to consume whatever amount of the fuel is desired. In most cases, it would be desirable to consume substantially all of the fuel in the stream 40, 42, 44, 46, . . . , so that the effluent N8 will have practically no fuel left in it and will be comprised mostly of carbon dioxide, water, and whatever oxidant is left. The initial fuel concentration in the initial influent 40 can be as high as desired, as long as there is enough water for the first anode reaction in the first cell 1. As shown by equation (1), the ratio of fuel molecular consumption to water molecular consumption is one to one, i.e., for every molecule of methanol (CH₃OH) consumed, one molecule of water (H₂O) is consumed. Therefore, for example, if three percent of the fuel can be consumed in the first cell 1, the maximum fuel concentration in the fuel-water part of the mixture would be 97% in order to have 3% water available for the first anode 11 reaction. For purposes of this invention, high fuel concentration is considered to be at least fifty percent (50%) fuel (mole fraction) in the fuel-water mixture, preferably at least seventy percent (70%), and more preferably at least ninety percent (90%). The amount of fuel consumed by each cell 1, 2, 3, . . . , N depends on a number of variables, including surface areas of the respective anodes and cathodes in each cell, fuel concentration, catalyst selectivity, and the electric current passing through the cell.

The amount of fuel consumed by each cell 1, 2, 3, . . . , N also determines the amount of electric current produced by each cell 1, 2, 3, . . . , N. As mentioned above, the contact pairs, 14-15, 24-25, 34-35, . . . , N4-N5 are provided to conduct electric current into and out of the respective cells 1, 2, 3, . . . , N. Therefore, the cells 1, 2, 3, . . . , N can be connected together electrically either in parallel, in series, or some combination of parallel and series. For cells connected electrically in series, each cell in the series will carry the same current. The voltage in each cell will depend on the reactant concentration, and the cell current density (mA/cm²), among other parameters. A high cell voltage is desirable for efficient operation. Therefore, since fuel concentration is a factor in cell voltage, the decreasing fuel concentration in each successive cell 1, 2, 3, . . . , N in the series may make it desirable to increase the anode and cathode area of each successive cell to compensate for the decreasing fuel concentration, lowering the cell current density and increasing the cell voltage beyond the value that would be obtained from the uniformly sized cells. Such variation in sizes of anodes and cathodes from cell to cell is feasible, because mixed-reactant fuel cells, unlike prior art fuel cell stacks, do not require the bulky and complex-structured bipolar plates used to route different streams of various reactants and effluents inside the stack.

A preferred cell structure for use with this invention is shown in FIG. 3, in which the component reference numbers are the same for consistency as those in FIG. 1. While only the first fuel cell 1 is shown in FIG. 3, it is typical of the other cells 2, 3, . . . , N in the stack. In FIG. 3, the oxidant is depicted as air, but it could also be any other gaseous or liquid oxidant, such as pure oxygen, mixtures of oxygen and other gases, hydrogen peroxide, nitric acid, or any other oxidizing agent. The preferred fuel is methanol, but this invention can be used with hydrogen fuel or any other oxidizable fuel that can be used in conventional fuel cells, such as hydrocarbons, alcohols or hydrides.

As illustrated in FIG. 3, the anode 11, cathode 12, and electrolyte membrane 13 are preferably porous, so the fuel and oxidant mixture 40 can be flowed directly through the anode 11, membrane 13, and cathode 12 in the direction of the axis 10. The respective selective catalysts are coated onto the porous surfaces of the anode 11 and cathode 12. Examples of selective catalysts for anode reactions include platinum-ruthenium compounds. Examples of selective catalysts for cathode reactions include ruthenium-selenium compounds, rhodium-sulfur compounds, and metal porphyrin compounds, such as Co-TMPP.

Since the principal function of the electrolyte 13, 23, 33, . . . , N3 is to separate the respective anode-cathode pairs 11-12, 21-22, 31-32, . . . , N1-N2 electrically while allowing unfettered migration of the protons (H⁺) from the anodes to the cathodes, there are many suitable materials that can be used for the electrolyte membrane 13, as long as they are electrical insulators and permeable to protons. Of course, the flow-through design of cell 1 also requires that the membrane 13 be porous to allow the flow of the reactants axially through the cell 1. Examples of suitable materials for the porous electrolyte membrane 13 include Nafion and alternative membranes such as those produced by Polyfuel, Inc., of Mountain View, Calif.

A gas diffusion layer 16 is provided for distributing reactants over the surfaces of the electrodes. Suitable materials for the gas diffusion layer 16 include carbon fiber cloths or felts.

Of course, in use, the anode 11, membrane 13, cathode 12, and gas diffusion layer 16 are all placed together in physical contact with each other, not spread apart as depicted in FIG. 3. The overall thickness of each cell 1, 2, 3, . . . , N can be about 0.2 mm. Also, the plurality of cells 1, 2, 3, . . . , N in a stack can be placed next to each other with only the gas diffusion layer 16 separating the cathode 12 of one cell 1 anode 21 of the second cell 2, and likewise throughout all the cells 1, 2, 3, . . . , N in a stack 100.

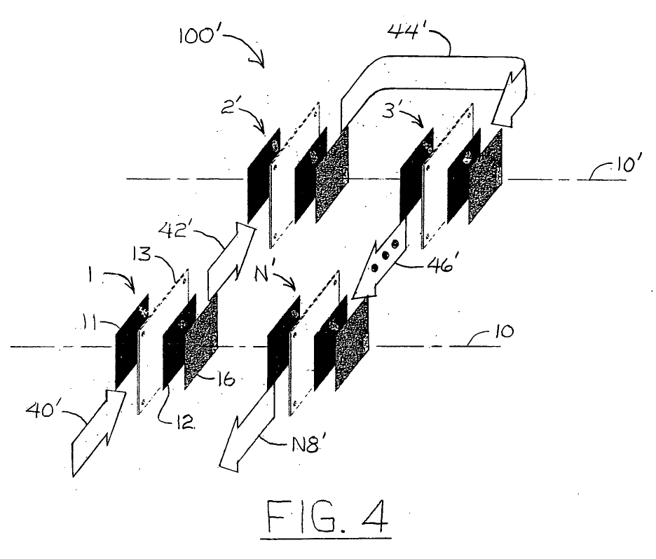

Of course, it is also feasible to flow the mixed-reactants through the cell 1 parallel to the anode 11 and cathode 12, as indicated in FIG. 4. In that kind of stack arrangement 100′, a plurality of cells 1, 2′, 3′, . . . , N′ can be placed side-by-side and/or end-to-end in any linear or matrix configuration with each successive cell in the mixed-reactant flow 40′, 42′, 44′, 46′, . . . , N8′ consuming an incremental amount more of the fuel until it is substantially all consumed, as described above for the axial flow of FIG. 1.

In practice, the cells can be stacked or arranged in any structure or chamber, such as a pipe, box, or other container that can confine and direct the mixed-reactant flow through the cells in the desired manner, as is within the skills and capabilities of persons skilled in the art, once they understand the principles of this invention.

As mentioned above, the oxidant in the single-pass, mixed-reactant fuel cells of this invention can be liquid or gaseous. The fuel can be liquid, too, but there are advantages to using a mixed-reactant stream with vaporized fuel, especially when gaseous oxidant, such as the oxygen in air, is used.

As also mentioned above, the single-pass, mixed-reactant fuel cell stacks of this invention can significantly reduce the complexity of fuel cell generation systems. An example of such a single-pass, mixed-reactant fuel cell generation system 110 is illustrated schematically in FIG. 5. The fuel—methanol in this example—is drawn from a fuel storage tank 112 and pumped by a pump 114 to a fuel vaporizer 116, where it is vaporized in preparation for delivery to the mixed-reactant stack 100. A blower 118 delivers air as the oxidant (i.e., natural oxygen in air) to be mixed with vaporized fuel in the influent inlet conduit 120 for introduction into the stack 100 of fuel cells. In the stack 100, the fuel and oxidant are directed through the cells as described above for cells 1, 2, 3, . . . , N of FIG. 1 (or 1, 2′, 3′, . . . , N′ of FIG. 4), where the fuel is consumed to produce electricity. The electricity is delivered to a load (not shown) by appropriate electric conductors 122. The effluent of primarily carbon dioxide (CO₂) and water (H₂O) as well as remaining air constituents any residual fuel, which is minimal—ideally none—is exhausted through an exhaust outlet 124. Heat generated by the reactions in the stack 100 can be used to help vaporize the fuel in the vaporizer 116. If there is a significant amount of residual fuel in the exhaust (tail gas), it can be burned and the heat used in the vaporizer 116 to help vaporize the fuel.

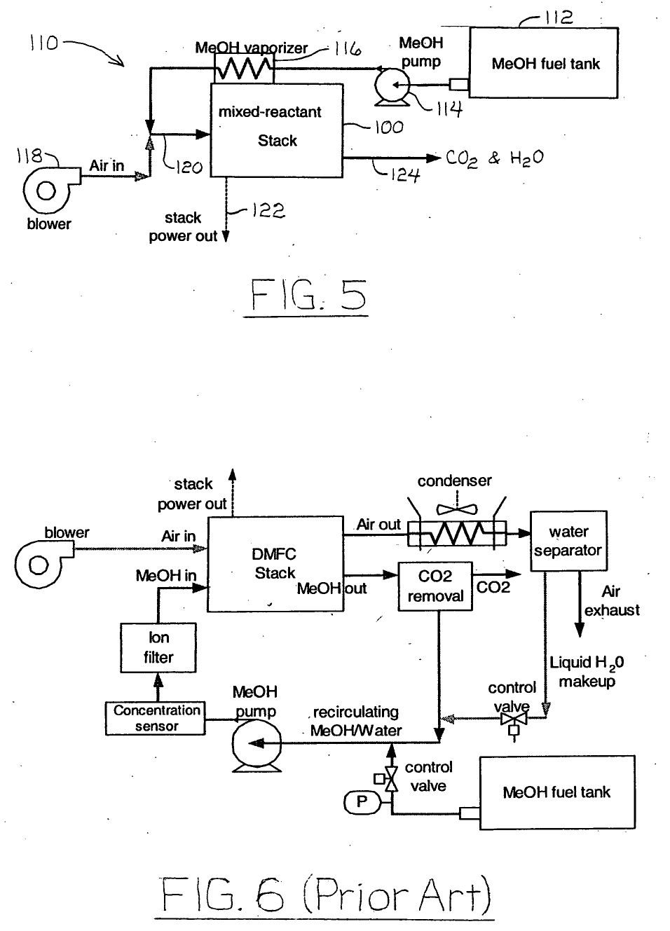

The single-pass, mixed-reactant, fuel cell generator system 110 shown in FIG. 5 has only five essential components (fuel cell stack 100, fuel tank 112, fuel pump 114, vaporizer 116, and air blower 118), ten connections, no sensors, and no valves. In contrast, the conventional DMFC system shown in FIG. 6 is much more complex with its eleven components (including two sensors and three valves), and twenty-four connections. The necessity of separating the unused methanol from the reaction byproducts and of recirculating the fuel through the stack, while keeping the fuel concentration in a tightly controlled range, is the cause for the complexity in conventional DMFC systems. Those requirements are eliminated by the single-pass, mixed-reactant fuel cell system of the present invention. Therefore, the specific energy (electric energy production per unit of weight) is much higher in the single-pass, mixed-reactant system of the present invention than is possible in conventional DMFC systems. For example, a single-pass, mixed-reactant system 110 of FIG. 5 sized to provide 1,440 watt-hours of energy at 20 watts average power can be made with normal materials to have a dry mass of about 460 grams, and the system plus fuel is 0.98 kilograms, which has a specific energy of 1,021 watt-hours per kilogram. By comparison, a 860 gram dry mass—1.4 kilogram prior art DMFC system with about the same amount of fuel—can provide a specific energy of only about 714 watt-hours per kilogram.

Also, by operating the system 110 of this invention with all of the reactants and reaction byproducts in the vapor or gaseous phases, an unexpected benefit is gained in reducing the power required to pump the reactants through the stack 100 (or 100′ in FIG. 4). In a conventional DMFC fuel cell system, such as the one shown in FIG. 6, liquid methanol-water mixtures are fed to the anode with a first feed system, and air is fed to the cathode with a second feed system. The cell operation produces carbon dioxide gas on the anode side and water on the cathode side, as explained above. The water produced on the cathode side can block reaction sites on the electrolyte membrane, so relatively high velocity air flows in small passages are typically used in such conventional DMFC systems to remove the product water. Such high velocity air flows in small passages lead to substantial pressure drops on the cathode air side (typically more than 5,000 Pa), which leads to a significant parasitic power consumption from the cathode air blower. In fact, the power required to provide air to the cathode is either the first or second largest parasitic power draw in conventional DMFC systems.

In contrast, the single-pass, mixed-reactant fuel cell generator system 110 of this invention, where all of the reactants are in the vapor phase, high velocity flows are not required to sweep liquid product water from the stack 100. Lower velocity air flows require less pumping power, which reduces parasitic power losses and increases overall system efficiency.

As mentioned above, in one preferred embodiment a 100, the stack 100 is constructed with porous cells 1, 2, 3, . . . , N and operated in an axial flow-through mode, i.e., flow in the direction of the axis 10 in FIG. 3. In this axial flow arrangement, a large cross-sectional area is available to the flow, and very low pressure drops are observed. Low pressure drops lower the required pumping power and increase system efficiency. Lower pressure rise air blowers can also be smaller and quieter than higher pressure rise blowers, which provides additional benefits in system size and noise. Therefore, the operation of mixed-reactant fuel cells with higher fuel concentration, single-pass utilization leads not only to system simplification, but also to unexpected benefits, including the ability to produce smaller, quieter, and more efficient fuel cell generator systems.

Since these and numerous other modifications and combinations of the above-described method and embodiments will readily occur to those skilled in the art, it is not desired to limit the invention to the exact construction and process shown and described above. Accordingly, resort may be made to all suitable modifications and equivalents that fall within the scope of the invention as defined by the claims which follow. The words “comprise,” “comprises,” “comprising,” “have,” “having,” “include,” “including,” and “includes” when used in this specification and in the following claims are intended to specify the presence of stated features, components, or steps, but they do not preclude the presence or addition of one or more other features, components, steps, or groups thereof.

The embodiments of the invention in which an exclusive property or privilege is claimed are defined as follows:

1. Fuel cell generator apparatus, comprising:
a plurality of fuel cells, each of which comprises an anode and a cathode separated by a non-electrically conductive, porous membrane, wherein the anode comprises an anode reaction selective catalyst and the cathode comprises a cathode reaction selective catalyst; and
means for directing a flow of high concentration fuel mixed with oxidant reactants sequentially through the fuel cells so that each of the fuel cells consumes a portion of the fuel in the mixed flow so that the fuel concentration decreases incrementally in each of the cells.

2. The fuel cell generator apparatus of claim 1, including enough fuel cells to consume at least half of the fuel.

3. The fuel cell generator apparatus of claim 1, including enough fuel cells to consume the fuel in the mixed-reactant flow from a high concentration to a concentration of less than ten percent (mole fraction).

4. The fuel cell generator apparatus of claim 1, wherein the means for directing the flow of fuel mixed with oxidant directs the flow axially through the fuel cells.

5. The fuel cell generator apparatus of claim 1, wherein the anode and cathode are porous, and the means for directing the flow of fuel mixed with oxidant directs the flow through the cells parallel to the anodes and cathodes.

6. The fuel cell generator apparatus of claim 4, wherein the anodes and cathodes of successive fuel cells have larger surface areas than the anodes and cathodes of preceding fuel cells.

7. Fuel cell generator apparatus, comprising:
a mixed-reactant fuel cell stack; and
a fuel source and an oxidant source, wherein the fuel and oxidant are mixed and flow sequentially through fuel cells in the stack in contact with anodes and cathodes in the respective fuel cells to consume at least half of the fuel in one pass of the mixed-reactant through the stack.

8. The apparatus of claim 7, wherein the fuel flowing into the stack has a concentration of at least fifty percent (mole fraction).

9. A mixed-reactant, direct methanol fuel cell stack comprising a plurality of fuel cells operated with a mixed methanol-water-air feed, wherein the methanol-to-water molar ratio in the feed is greater than 1:1, and wherein the fuel and air mixture flows sequentially through the plurality of fuel cells such that at least half of the fuel in the feed is consumed incrementally by the plurality of fuel cells.

10. The mixed-reactant, direct methanol fuel cell stack of claim 9, wherein the fuel, air, and water in the feed are all in their respective vapor phases.

11. The mixed-reactant, direct methanol fuel cell stack of claim 9, including a tail-gas combustor connected in fluid flow relation to the stack to receive and combust residual fuel in exhaust from the stack.

12. A method of generating electric power, comprising:
flowing a mixture of high concentration fuel mixed together with an oxidant into a stack of a plurality of fuel cells, each of which comprises an anode with an anode reaction selective catalyst and a cathode with a cathode reaction selective catalyst separated by a non-electrically conductive, porous membrane, and, in the stack, flowing the mixture sequentially through the fuel cells in a manner that contacts the flow with the anode reaction selective catalyst and the cathode reaction selective catalyst so that each cell consumes some of the fuel to produce electric current, whereby the fuel concentration is reduced incrementally by each of the fuel cells.

13. The method of claim 12, wherein the anodes and cathodes are porous, and including flowing the mixture axially through the anodes and cathodes of the fuel cells.

14. The method of claim 12, including flowing the mixture through the fuel cells in contact with the anodes and cathodes of the fuel cells.

15. The method of claim 13, including consuming at least half of the fuel in the mixture in a single-pass of the mixture through the stack.

16. The method of claim 13, including consuming enough of the fuel in the stack to lower the fuel concentration to less than five percent.

17. The method of claim 12, including feeding the fuel and oxidant mixture in vapor phase into the stack.

18. The method of claim 12, including burning residual gas in effluent from the stack.

19. The method of claim 18, including using heat from said burning to vaporize the fuel for the feed.
